(19) United States
(12) Patent Application Publication
(10) Pub. No.: US 2003/0041409 A1
(43) Pub. Date: Mar. 6, 2003

(54) Adjustable-height castor system

(76) Inventor: John L. Caporale, Redmond, WA (US)

Correspondence Address: Richard R. Batt, Morrison & Foerster LLP, 755 Page Mill Road, Palo Alto, CA, 94304-1018, US

(21) Appl. No.: 10/185,912

(22) Filed: Jun. 27, 2002

Related U.S. Application Data
(60) Provisional application No. 60/301,634, filed on Jun. 28, 2001.

(51) Int. Cl. B60B 33/04

(52) U.S. Cl. 16/19

(57) ABSTRACT

The present invention includes an adjustable-height castor assembly for use with racks such as racks used to house computer servers. The castor assembly includes a frame or housing which may be fastened to a bottom of a rack. The castor assembly further includes a threaded vertical shaft with a round member (e.g., a swivel wheel or sphere) attached to the lower end of the vertical shaft. The wheel may be directly attached to the vertical shaft or indirectly attached to the vertical shaft via a castor plate or other support structure. The vertical shaft extends through a tapped support in the frame such that rotation of the vertical shaft raises or lowers the frame along the vertical shaft. The castor assembly further includes a drive shaft having a drive gear. A mating gear is mounted on the vertical shaft. The mating gear and the drive gear mesh or interlock such that when the drive gear rotates, the mating gear rotates. Accordingly, rotating the drive shaft rotates the mating gear and vertical shaft thus raising or lowering the rack. The drive shaft may be driven by, for example, a power tool such as a drill. Methods and systems for adjusting castor assembly height are also provided.

### CROSS-REFERENCE TO RELATED APPLICATIONS

This application claims priority to Provisional Application Serial No. 60/301,634 filed Jun. 28, 2001.

### FIELD OF THE INVENTION

The present invention generally relates to castors for use with racks and in particular, it relates to height-adjustable castor assemblies for use with electronic equipment racks.

### BACKGROUND OF THE INVENTION

Racks provide space for housing various equipment including computer servers, audio, telecommunication, security and other types of equipment. Racks come in various sizes depending on the type of equipment housed. For example, racks for housing computer servers may be about 24 inches wide, 44 inches deep, and up to about 88 inches tall. Computer server racks typically have an interior width of 19 inches and may weigh 1500 pounds or more depending on the particular rack configuration and type of equipment housed therein. An example of a rack or 19″ enclosure is WRK Series Enclosure Model Number WRK-44-32 sold by Middle Atlantic Products, Inc.

Due to their size and weight, racks are extremely difficult to lift, move and install. Typically, castors are attached to the bottom of the racks and the racks are pushed on the castors into a desired location. After rolling the racks into position, racks are typically set in place using leveling feet. This is done for stability, seismic bracing and safety; it also prevents the castors from developing flat spots after standing in position for years under a heavy load.

The industry standard method for installing the racks includes manually cranking leveling feet down onto the floor using hand tools such as a wrench or screw driver, thereby raising the castors off the floor. Manual cranking is done from underneath the racks and is physically demanding and time consuming. In a rack full of computers cranking the leveling feet onto the floor can take up to 20 minutes or more. When installing hundreds of racks, a significant amount of time is required to complete installation. The cost of labor is also substantial.

When a pre-installed rack is to be moved, it is equally costly and time consuming as the installation itself. Each of the rack's leveling feet must be cranked upward into a position clear from the floor. Once the leveling feet are clear from the floor and the castors are in contact with the floor, the rack may then be rolled. This procedure suffers from the same shortcomings as the installation procedures discussed above.

Poor cooling efficiency is another drawback, which arises from conventional rack installations. Conventional rack installations set racks several inches off the floor creating an open space. This space can decrease the cooling efficiency of the racks, particularly when the racks are cooled from below which is a common method for ventilating electronic equipment racks.

It is therefore desirable to provide a castor assembly without the above mentioned shortcomings.

### SUMMARY OF THE INVENTION

The present invention includes a height adjustable castor assembly for use with racks such as racks used to house computer servers. The castor assembly includes a frame or housing which may be fastened to the bottom of a rack. The castor assembly further includes a threaded vertical shaft with a wheel mounted to the lower end of the vertical shaft. The wheel may be directly attached to the vertical shaft or indirectly attached to the vertical shaft via a castor plate or other support structure. The vertical shaft extends through a tapped support in the frame such that rotation of the vertical shaft raises and lowers the frame along the vertical shaft. The castor assembly further includes a drive gear mounted on (or integral with) a drive shaft and a mating gear mounted on (or integral with) the vertical shaft. The mating gear and the drive gear interlock such that when the drive gear is rotated, the mating gear rotates. Rotating the drive shaft thus rotates the vertical shaft, which raises and lowers the rack. The drive shaft may be driven by, for example, a power tool such as a drill. The drive gear and the mating gear may be a worm and worm gear respectively. The drive gear and the mating gear may be helical gears.

In a variation of the present invention, a drive shaft extends between and links two castor assemblies. Each castor assembly includes a threaded vertical shaft. The drive shaft and the vertical shafts are geared such that when the drive shaft rotates, each vertical shaft rotates. Rotation of the vertical shafts urges the castor housings upwards or downwards thereby adjusting the height of the castor system.

In another variation of the present invention, a castor system includes four castor assemblies linked together via a drive train. Two castor assemblies on the left side are linked with a drive shaft and two castor assemblies on the right side are linked with a second drive shaft. The castor system further includes a drive train that links the two drive shafts. The drive train includes two castor boxes or enclosures and a horizontal shaft extending therebetween. Each castor box supports the horizontal shaft and a drive shaft. In one variation, helical gears are mounted to the horizontal shaft and the drive shaft such that rotation of one drive shaft transmits rotation to the other drive shaft. At least one of the drive shafts may include a keyed end. A tool such as a drill may be used to rotate the drive shaft thereby raising or lowering all four castor assemblies simultaneously.

Another variation of the present invention includes a method for adjusting castor assembly height. The method includes using the castor assemblies as described herein.

Another variation of the present invention includes a method for leveling a rack. The method comprises using independent (unlinked) castor assemblies as described herein to individually lift or lower a bottom portion of a rack. For example, an individual corner or side of the bottom of a rack may be lifted. Spheres, in place of wheels, may also be used in accordance with the present invention. The drive shafts of the present invention may be manipulated manually or with power tools such as a drill.

Another variation of the present invention includes a rack system which can be raised and lowered using hydraulic pressure.

Still other variations and features of the present invention will become apparent upon reading the following disclosure and claims in conjunction with the attached drawings.

### BRIEF DESCRIPTION OF THE DRAWINGS

FIG. 1 is a perspective view of a castor assembly in accordance with the present invention.

FIG. 2 is a cross sectional view of the castor assembly shown in FIG. 1 taken along A-A.

FIG. 3 is a cross sectional view of the castor assembly shown in FIG. 1 taken along B-B.

FIG. 4A is a partial front view of a castor assembly in accordance with the present invention.

FIG. 4B is a top view of the components shown in FIG. 4A.

FIG. 4C is an illustration of another castor assembly including a rack and pinion in accordance with the present invention.

FIG. 5 is a left side view of a castor system in accordance with the present invention.

FIG. 6 is a front view of the castor system shown in FIG. 5.

FIG. 7 is a partial exploded view of a castor system having a drive train in accordance with the present invention.

FIG. 8 is an illustration of a rack system having a hydraulically driven frame.

### DETAILED DESCRIPTION OF THE INVENTION

The present invention is a height adjustable castor assembly for use with racks such as racks used to house computer servers. The novel castor assembly includes a frame or housing which is fastened to the bottom of a rack. The castor assembly further includes a threaded vertical shaft with a castor wheel attached to the lower end of the vertical shaft. The wheel may be directly attached to the vertical shaft or indirectly attached to the vertical shaft via a castor plate or other support structure. The vertical shaft extends through a tapped opening in the frame such that rotation of the vertical shaft raises or lowers the frame of the castor assembly. The castor assembly further includes a drive gear and a mating gear. The mating gear is mounted on the vertical shaft and the drive gear is mounted to the drive shaft. The mating gear interlocks with the drive gear such that when the drive shaft is rotated, the mating gear and the vertical shaft rotate. Manipulation of the drive shaft thus causes the castor assembly to raise or lower. Further, the castor assembly may be used to lower a rack bottom onto the floor. In a rack having a skirt attached to the rack base, the present invention can be used to lower the skirt onto the floor.

Referring to FIG. 1, a castor assembly 10 is shown in accordance with the present invention. The castor assembly 10 includes a housing or frame 20. The housing 20 may be fabricated from steel components fastened, welded, or otherwise secured together. The housing 20 may feature one or more holes 30 for receiving fasteners. The fasteners attach the castor assembly to the bottom of a rack (not shown). The fasteners may also attach the castor assembly to a rack base which is secured to the bottom of typical racks. The castor housing 20 also may feature a pass-through or access port 40 for tools, such as a drill, to be inserted. Both manual and power tools may be used to raise and lower the rack as will be discussed in more detail below.

Extending vertically from the bottom of the housing 20 is a threaded shaft 50. A castor wheel 60 is mounted to the lower end of the vertical shaft. The castor wheel is rotateable and may be disk-shaped, circular or spherical. For example, heavy duty 3″ swivel wheels are suitable. The castor wheel may be mounted to the vertical shaft by, for example, a mounting plate 70. Mounting plates may be welded or otherwise attached to the threaded shaft 50.

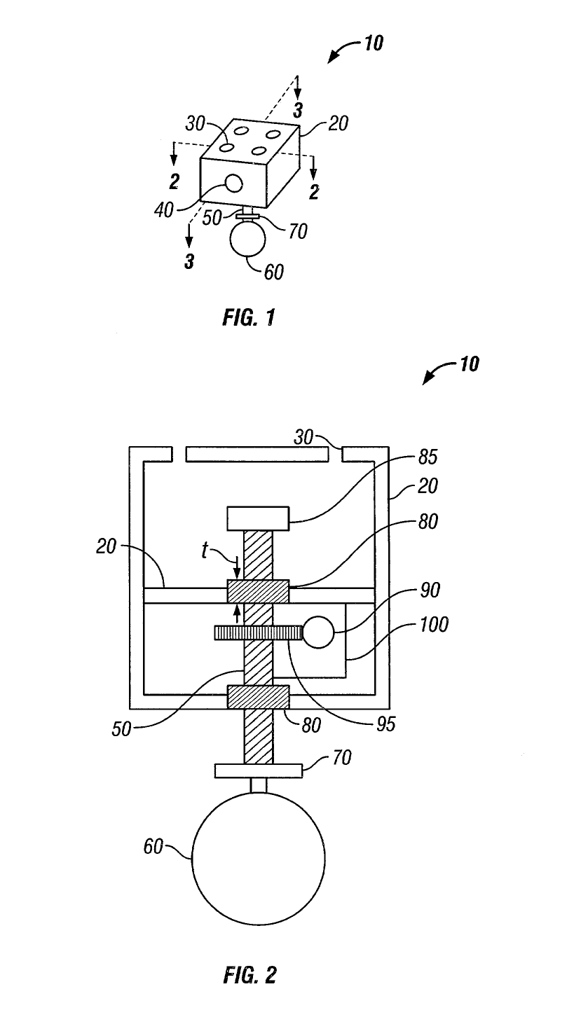

FIG. 2 depicts the inner workings of an exemplary castor assembly 10. In particular, FIG. 2 shows vertical shaft 50 extending through vertical supports 80. At least one of the vertical supports 80 is tapped to match the threads of vertical shaft 50. Two vertical supports may be tapped to provide more stability to the assembly. Also, the vertical supports may have an increased thickness t to support more threads and to provide greater stability to the system. Vertical supports 80 may be integral or separate components attached to the frame 20. Suitable techniques for attaching the vertical supports to the frame 20 include but are not limited to welding.

The tapped vertical support or opening 80 enables the frame or housing 20 to move along the vertical shaft when the vertical shaft 50 is rotated. Thus, the castor assembly may be adjusted vertically by controlling the rotation R of vertical shaft. Moreover, a rack attached to the castor assembly may be raised or lowered from the floor by controlling the motion of the vertical shaft.

Further height control may be accomplished using a stop 85. Stop 85 contacts frame 20 when vertical shaft extends from the housing 20 beyond a desired range. Stop 85, which is attached or integral to vertical shaft 50, has a larger diameter than the inner diameter of vertical opening or support 80 and thus, prevents further downward movement of the vertical shaft 80. Suitable materials for the vertical shaft and stops include but are not limited to steel. The stop may be attached by, for example, welding.

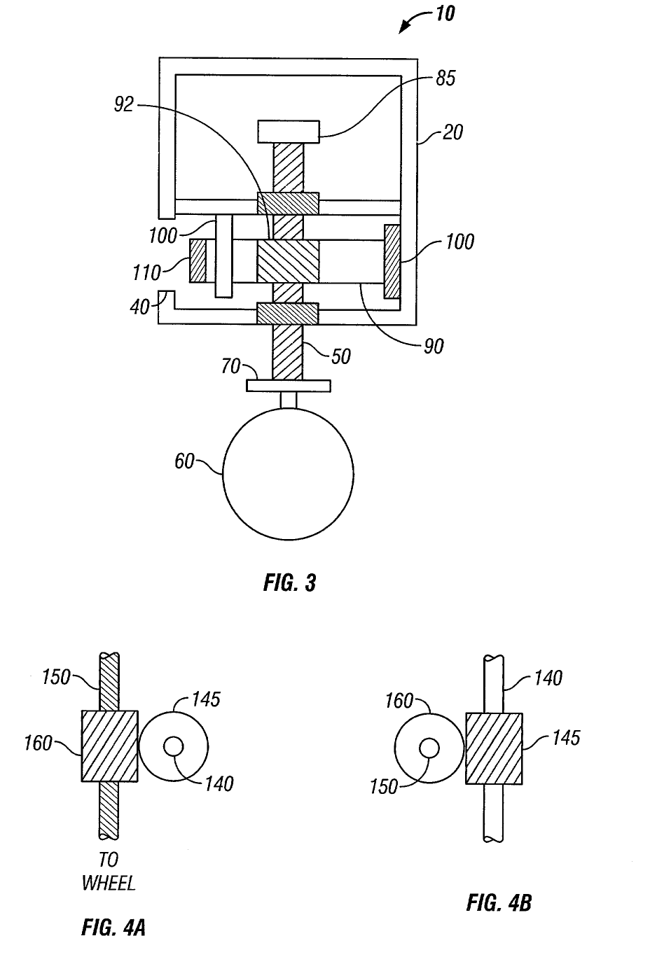

Also shown in FIG. 2 is a drive shaft 90 and gear 95. The drive shaft includes a threaded portion 92 (FIG. 3) which mates with the teeth of gear 95 such that rotation of the drive shaft rotates the vertical shaft. Therefore, the castor assembly may be adjusted in height by rotation of the drive shaft.

Drive shaft 90 is shown in FIG. 3 perpendicular to vertical shaft 50. Drive shaft 90 is also shown as not intersecting vertical shaft 50. Suitable gear types for non-intersecting and perpendicular shafts are worm and worm gears as well as helical gears. Preferably, the gears of the present invention are readily available from gear manufacturers. However, the gears may also be custom designed. Suitable materials for the gears and shafts include but are not limited to aluminum, cast iron, mild steel, hardened steel and alloyed steel.

Drive shaft 90 and gear 95 may be a worm and worm gear respectively. Drive shaft 90 is held in place via horizontal supports 100. Unlike vertical supports 80, however, horizontal supports may not be threaded. Horizontal supports may include bearings which allow frictionless rotation of the drive shaft yet fix the drive shaft securely to the castor frame 20.

The drive shaft may be rotated using a power tool inserted into access port 40. Preferably, drive shaft 90 includes a keyed end 110 such that a tool may be inserted therein to turn the drive shaft. A suitable end 110 includes an enlarged hexagonal cavity. A suitable tool for manipulating (e.g., turning or cranking) the drive shaft includes a power drill having tool bits that removeably engage the end 100. Preferably, the keyed end is integral with the drive shaft but the keyed end may also be welded or otherwise securely fastened to the drive shaft.

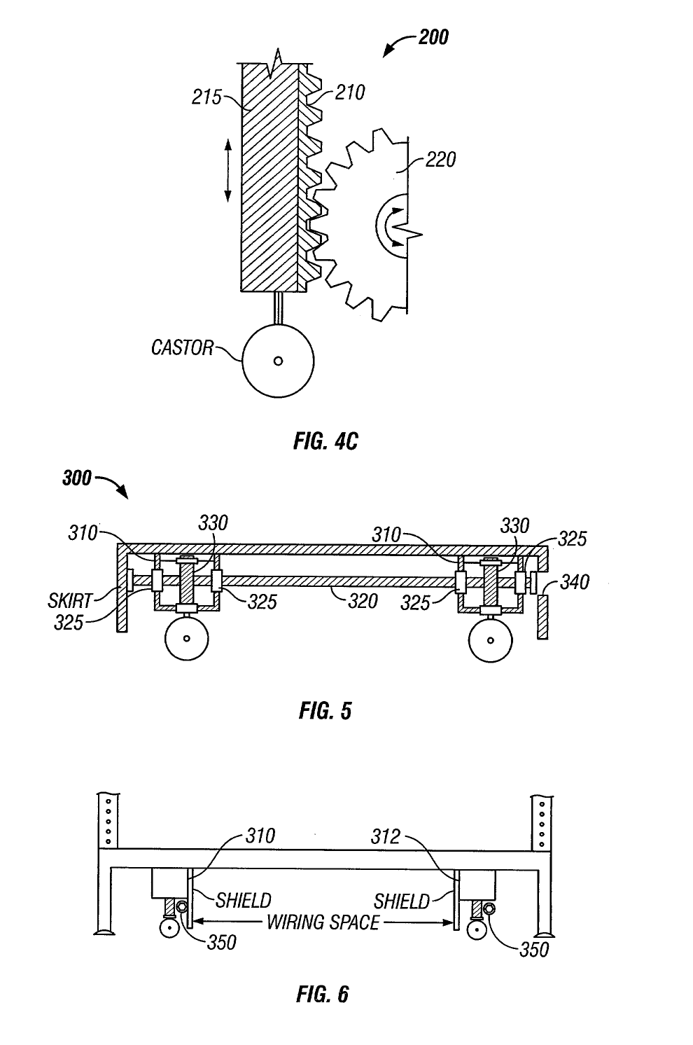

A variation of the above described gearing scheme is illustrated in FIGS. 4A and 4B. In particular, FIGS. 4A and 4B are partial front and top views respectively of a helical gear pair used in accordance with the present invention. Helical gears may be utilized in transmitting motion between non-parallel and non-intersecting shafts similar to a worm (shaft) and worm gear.

In the embodiment shown in FIGS. 4A and 4B, drive shaft 140 includes helical drive gear 145. Vertical threaded shaft 150 includes helical mating gear 160 which mates with drive gear 145. When drive shaft 140 is rotated, motion is transmitted to vertical shaft 150 thereby raising and lowering the castor frame.

FIG. 4C illustrates another variation of the present invention. In particular, castor assembly 200 includes a rack and pinion design that provides vertical adjustment to the castor assembly. Bar 210 is shown attached to vertical shaft 215. Pinion 220 mates with the teeth of bar 210 such that rotation of the pinion 220 raises or lowers bar or rack 210. The other components of the assembly such as the frame or housing (not shown) may be similar to that described above.

The present invention also includes other gearing schemes for rotating the vertical shaft thereby causing the castor assembly to move up or down along the vertical shaft. For example, bevel or miter gears may be employed. A pinion bevel gear may be fixed to the drive shaft and a mating gear may be fastened to the vertical shaft. Bevel gears are advantageous when the shafts are intersecting. Still other gearing schemes may be employed to rotate the vertical shaft as is known to those skilled in the art including but not limited to use of spur gears.

FIG. 5 depicts a left side view of a castor system 300. In FIG. 5, two castor assemblies 310 are shown linked via an extended drive shaft or actuator 320. The castor assemblies 310 are similar to the castor assemblies described above except that drive shaft 320 is extended and is geared to two castor assemblies 310. Castor assemblies 310 include lateral openings 325 in their frames, which are preferably friction free. Bearings are suitable for providing low friction lateral support to the drive shaft.

A suitable drive shaft 320 is an elongated steel shaft having a threaded portion that meshes with a gear (not shown) in each of the two castor assemblies 310. Thus, when the drive shaft 320 rotates, the vertical shafts 330 of each of the two castor assemblies 310 rotate. Rotation of the vertical shafts 330 urges the castor housings upwards or downwards along the vertical shafts 330.

Preferably, an access port 340 is provided for receiving a tool to rotate the drive shaft 320. Suitable tools include, for example, a drill and drill bit which mate with the end of the drive shaft.

FIG. 6 is a front view of the castor system shown in FIG. 5 and shows both the left and right side castor assemblies 310 and 312 respectively. However, since it is a front view, the left and right rearward castor assemblies 310 and 312 are not visible in this drawing. The configuration depicted in FIG. 6 is distinct from the previous embodiments because the castor assemblies shown in FIG. 6 are linked. In operation, two drive shafts are rotated to raise and lower all four castor assemblies. Keyed ends 350 are provided at the front ends of the drive shafts to provide convenient access to tools useful in rotating the drive shafts.

In the earlier described embodiments, each of the castor assemblies featured a drive shaft independent of the other castor assemblies. Thus, in order to raise or lower all the castor assemblies, each drive shaft must be rotated.

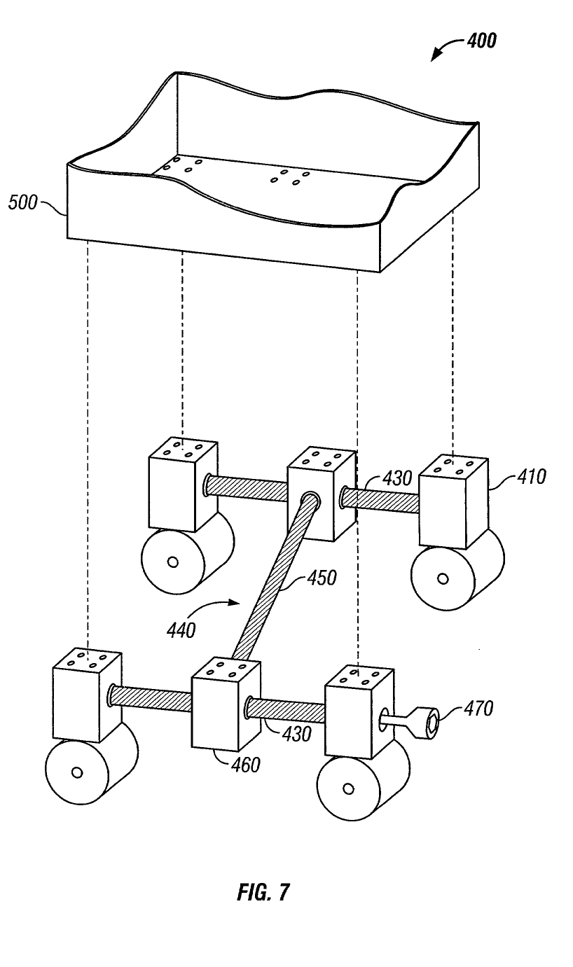

FIG. 7 illustrates yet another variation of the present invention. The castor system 400 is similar to the castor systems described in FIGS. 5 and 6 except that drive shafts 430 are linked via a drive train 440. Drive train 440 includes a horizontal shaft 450 and two gear boxes 460. Rotation of one drive shaft causes the other drive shaft to rotate via drive train 440.

Suitable types of gears for drive train 440 include worms, worm gears, helical gears, spur gears, bevel gears, and miter gears. Preferably, horizontal shaft 450 is non-intersecting and non-parallel to drive shafts 430. Helical gears are preferably attached to the drive shaft and horizontal shaft to transmit motion from one shaft to the other. Support for the horizontal shaft 450 is provided by lateral supports or openings in gear boxes 460. Accordingly, rotating one of the drive shafts causes rotation of all vertical shafts thereby raising or lowering the rack 500. A keyed end may also be mounted to an end of one the drive shafts. The keyed end is adapted to receive a tool such as a drill.

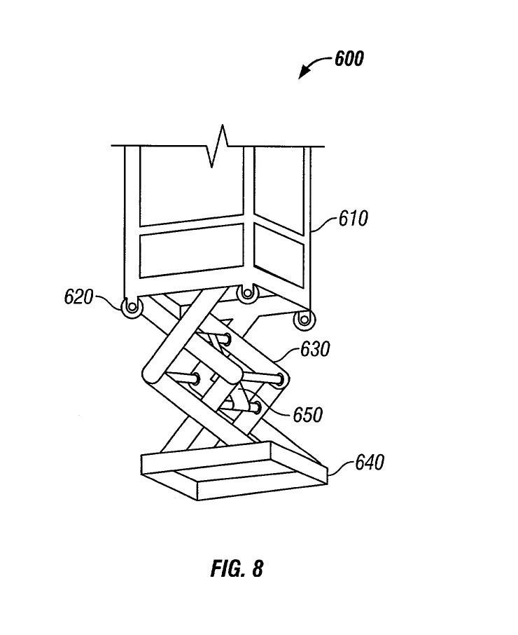

FIG. 8 illustrates another embodiment of the present invention. In particular, FIG. 8 shows a rack system 600 including a rack 610, castors 620, frame 630 and floor stand 640. The frame 630 includes a number of movable members coupled at various joints. The frame is coupled such that it is movable between an extended position and a compact configuration. When the frame is extended, the rack connected thereto is elevated from the floor. In contrast, when the frame is in a compact position, the rack is lowered such that the castors contact the floor. Once the castors contact the floor, the rack system may be rolled to another location.

The rack system 600 may be hydraulically driven. A hydraulic cylinder 650 may be fastened to members of frame 630 such that activating the cylinder causes the rack to raise or lower. Alternatively, other driving assemblies may be employed to raise or lower the racks. Alternate assemblies include but are not limited to a manual crank or a ratchet driving assembly.

Applications of the present invention include raising and lowering racks. That is, application of the present invention can adjust the height of racks and castor assemblies. While one aspect of the invention includes four castor assemblies linked together such that all four castor assemblies adjust height simultaneously, the invention is not so limited. One or two corners of a rack bottom may be raised at a time. In typical applications, the castors need only raise a rack about 0.75 inches. This small rise allows two corners of a rack to be raised at a time without comprising the structure's stability. Raising two corners simultaneously will not tip over the structure.

The present invention may also be used as a leveling device. In a preferred castor system for leveling applications, the castor wheels are solid and unlikely to deform under the weight of the racks.

The present invention also includes incorporating additional components such as guide rails (not shown) to maintain alignment of the moving parts of the castor assembly. For example, alignment between the frame and the vertical shaft may be accomplished using frictionless guide rails or linear bearings in addition to the features described above.

All of the features disclosed in this specification (including any accompanying claims, abstract and drawings), and/or all of the steps of any method or process disclosed, may be combined in any combination, except combinations where at least some of such features and/or steps are mutually exclusive. Each feature disclosed, in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1. A height-adjustable castor assembly comprising:
a frame;
a vertical shaft rotatably held by said frame, said vertical shaft at least partially threaded and extending through a tapped support in the frame such that rotation of the vertical shaft moves the frame relative to the vertical shaft;
a drive shaft rotatably held by said frame;
a drive gear on said drive shaft, said drive shaft and drive gear positioned such that said drive gear meshes with a mating gear on said vertical shaft, wherein when the drive gear is rotated, the mating gear rotates causing said vertical shaft to rotate thereby moving said frame relative to said vertical shaft; and
at least one round member rotatably mounted to a lower end of the vertical shaft.

2. The castor assembly of claim 1 wherein the mating gear is a worm gear.

3. The castor assembly of claim 1 wherein the drive gear and the mating gear are helical gears.

4. The castor assembly of claim 1 wherein the round member is attached to the vertical shaft via a plate.

5. The castor assembly of claim 1 wherein said round member is a sphere.

6. The castor assembly of claim 1 wherein said round member is a wheel.

7. The castor assembly of claim 1 wherein said mating gear is integral with said vertical shaft.

8. The castor assembly of claim 1 wherein said mating gear is separate from said vertical shaft and fixedly mounted to said vertical shaft.

9. A method for adjusting castor assembly height comprising driving said drive shaft of said castor assembly recited in claim 1.

10. A method for leveling a rack comprising a first castor assembly mounted to a bottom portion of a rack and a second castor assembly mounted to a bottom portion of said rack, each of said first castor assembly and said second castor assembly being configured the same as the castor assembly recited in claim 1, said method comprising:
driving a first drive shaft of said first castor assembly to vertically move a first frame of said first castor assembly; and
driving a second drive shaft of said second castor assembly to vertically move a second frame of said second castor assembly.

11. The method of claim 10 wherein said driving said first drive shaft causes said first frame to vertically move a greater distance than that of said second frame.

12. The method of claim 10 wherein said driving said first drive shaft is performed separate from driving said second drive shaft.

13. A height-adjustable castor system comprising:
at least a first castor assembly and a second castor assembly, each of said first castor assembly and second castor assembly comprising a frame, a threaded vertical shaft rotatably secured to said frame, and a round member mounted to a lower end of said vertical shaft; and
a first drive shaft having a first end and a second end and extending between said first castor assembly and second castor assembly, said first end of said first drive shaft being geared to said first vertical shaft and said second end being geared to said second vertical shaft such that when said first drive shaft rotates, each said vertical shaft rotates causing movement to each frame of said first castor assembly and second castor assembly.

14. The castor system of claim 13 comprising a third castor assembly and fourth castor assembly, said third castor assembly and fourth castor assembly being identical to said first castor assembly and second castor assembly, and said third castor assembly geared to said fourth castor assembly via a second drive shaft, such that when said second drive shaft is rotated each frame of said third castor assembly and fourth castor assembly moves.

15. The castor system of claim 14 further comprising a drive train linking said first drive shaft to said second drive shaft.

16. The castor system of claim 15 further comprising a rack, each of said castor assemblies being mounted to said rack such that vertical movement of said vertical shafts causes vertical movement to said rack.

17. The castor system of claim 15 wherein said drive train comprises two castor enclosures and a horizontal shaft extending therebetween, each castor enclosure rotatably supports the horizontal shaft such that a first end of said horizontal shaft engages said first drive shaft and a second end of said horizontal shaft engages said second drive shaft.

18. The castor system of claim 17 wherein said horizontal shaft engages at least one of said first drive shaft and said second drive shaft with a helical gear.

19. The castor system of claim 18 wherein at least one of said first drive shaft and second drive shaft comprises a keyed end.

20. The castor system of claim 13 wherein said round member is a sphere.

21. The castor system of claim 13 wherein said round member is a wheel.

22. A method for adjusting castor system height comprising driving at least one of said drive shafts of said castor system recited in claim 13.

23. A method for adjusting castor system height comprising driving one of said drive shafts of said castor system recited in claim 17.

24. The method of claim 23 wherein said driving is performed using a power tool.

25. The method of claim 23 wherein said driving is performed manually.
